(19) United States
(12) Patent Application Publication
(10) Pub. No.: US 2010/0205075 A1
(43) Pub. Date: Aug. 12, 2010

(54) LARGE-SCALE ITEM AFFINITY DETERMINATION USING A MAP REDUCE PLATFORM

(75) Inventor: Qiong ZHANG, Sunnyvale, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/369,160

(22) Filed: Feb. 11, 2009

(51) Int. Cl. G06N 5/02; G06Q 10/00; G06F 17/30; G06F 17/40; G06F 7/06

(52) U.S. Cl. 705/30; 706/52; 707/E17.044

(57) ABSTRACT

Pair-wise item affinity is based on transaction records. Each transaction record includes an indication of a bucket and an indication of an item transacted corresponding to that bucket. The method comprises a Phase 1 bucket filtering, Phase 2 item count, Phase 3 bucket materialization and Phase 4 pair count and affinity lift/calculation. The phases are ideally suited to be carried out by a computing system in a map-reduce configuration.

### BACKGROUND

By counting pair-wise co-occurrence of items (or terms) in user buckets (alternatively called transactions), one can measure the affinity between item pairs. More particularly, an affinity is a measure of association between different items. A person may want to know an affinity among items in order to identify or better understand possible correlation or relationships between items such as events, interests, people or products. An affinity may be useful to predict preferences. For instance, an affinity may be used to predict that a person interested in one subject matter also is likely to be interested in another subject matter, to make an item-based recommendation.

Taking music as an example, a music recommendation engine may recognize that people who downloaded Song A also downloaded Song B. Therefore, a user X who has downloaded Song A may also be interested in downloading Song B, and Song B is recommended to user X.

Two commonly used measures are:

Affinity(A, B)=P(B|A)=N(A ̂B)/N(A)

Lift(A, B)=P(B|A)/P(B)=N(A ̂B)/N(A)*N(B)

While affinity is a measure of prevalence of a second item in association with a first item, lift is also a measure of the relative prevalence of the first item with the second item, but also taking into account the popularity of the second item. Put another way, lift is a measure of the extent to which the conditional probability of the second item occurring relates to the overall unconditional probability of the second item occurring. Thus, for example, when lift is considered, a very popular “other item” will not skew the recommendation.

For a web-scale data set, items may number in the millions and users may number in the tens or even hundreds of millions.

### SUMMARY

In accordance with an aspect, a computer-implemented method of determining pair-wise item affinity based on transaction records tangibly embodied in at least one computer-readable medium, each transaction record including an indication of a bucket and an indication of a item transacted corresponding to that bucket. The method comprises a Phase 1 bucket filtering to determine, a total number of potential item pairs across all the buckets in a partition and a total count of unique items for that partition. In a Phase 2 item count, it is determined, for each item, a count of the number of appearances of each item in all the buckets collectively and, for each item, that item is encoded based at least in part on the determined item distribution from Phase 1.

A Phase 3 bucket materialization includes, for each bucket, collecting into one record all item codes for items transacted in correspondence with that bucket. For each bucket, the one record for that bucket is processed to determine a number of item pairs that can be generated for that bucket and encoding that bucket based at least in part on the item pair distribution determined from Phase 1.

In a Phase 4 pair count and affinity lift/calculation, pairs of item codes are generated, and affinity statistics are generated based on the generated pairs of item codes. The generated pairs of item codes and affinity statistics are stored in a tangible computer-readable medium.

The phases are ideally suited to be carried out by a computing system in a map-reduce configuration.

### BRIEF DESCRIPTION OF THE DRAWINGS

FIG. 1 is a block diagram providing a simplified example of a four phase map/reduce processing to accomplish item pairwise affinity/lift determination.

FIG. 2 is a block diagram illustrating an example of first phase map stage processing.

FIG. 3 is a block diagram illustrating an example of first phase reduce stage processing.

FIG. 4 is a block diagram illustrating an example of second phase map stage processing.

FIG. 5 is a block diagram illustrating an example of second phase reduce stage processing.

FIG. 6 is a block diagram illustrating an example of third phase map stage processing.

FIG. 7 is a block diagram illustrating an example of third phase reduce stage processing.

FIG. 8 is a block diagram illustrating an example of fourth phase map stage processing.

FIG. 9 is a block diagram illustrating an example of fourth phase reduce stage processing.

FIG. 10 is a simplified diagram of a network environment in which specific embodiments of the present invention may be implemented.

### DETAILED DESCRIPTION

The inventor has realized that, for affinity and lift determinations, it can be infeasible to calculate all the pair-wise measurements on a single machine due to memory and time constraint. The inventor has thus realized that a parallel platform (for example, a map/reduce paradigm) may be used to make the affinity and lift determinations in a very efficient way. Furthermore, the determinations may be optimized by selectively utilizing integer or other coding such as described in U.S. Pat. No. 6,873,996, assigned to Yahoo Inc!, the assignee of the present patent application.

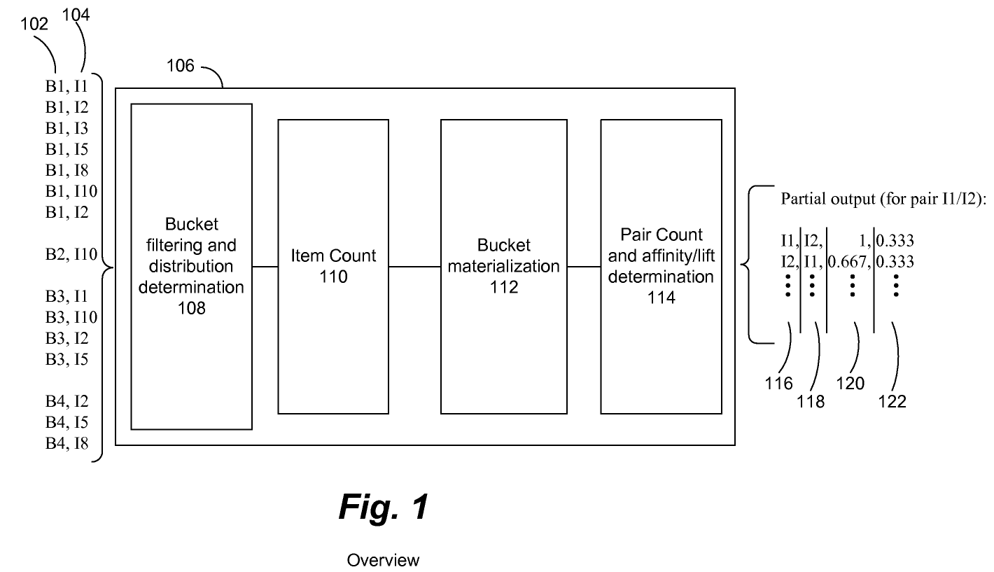

For example, referring to FIG. 1, a very simplified example is presented. In FIG. 1, the input data includes a column 102 of user identifications and a column 104 of item indications. This input data is provided to a map-reduce processing 106 including four phases 108, 110, 112 and 114. The output of the map-reduce processing 106 is an indication of item (column 116) to item (column 118) affinity and lift, with the affinity shown in column 120 and the lift shown in column 122. For examples, if the buckets are users and the items are web pages viewed by those users, determined affinities may be an indication of likelihood that a viewer of a first particular web page will view a second particular web page. In addition, in this same scenario, the determined lifts may be an indication of the relative prevalence of viewing the second particular web page by viewers of the first particular web page, but also taking into account the popularity of the second particular web page. This is just one example of tangible bucket and item input data, and there are many other known tangible bucket and item categories for which utility of affinity and lift determinations are known.

We now describe the map-reduce processing 106 broadly, in conjunction with FIG. 1. It is noted that the map-reduce paradigm, generally, is known. For example, reference is made to “MapReduce: Simplified Data Processing on Large Clusters,” Jeffrey Dean and Sanjay Ghemawat, believed to have been presented at OSDI'04: Sixth Symposium on Operating System Design and Implementation, San Francisco, Calif., December, 2004.

Various aspects of the map-reduce processing 106, relative to examples of determining affinity and lift, are described in greater detail later, with reference to a particular illustrative example. In the description, a “bucket” is a broad term for a category to which items may correspond, for affinity purposes, such as a “user” or other tangible entity who has transacted a particular actual tangible item. Throughout this description, we refer to a <bucket, item> pair as an indication of one actual tangible transaction of the “item” by the “bucket.”

Referring now to FIG. 1, in the illustrated example, the phases of map-reduce processing 106 include a first phase 108 of bucket filtering and distribution determination. That is, in the first phase 108, it is determined, for each partition (such as by using random hash), a total number of potential item pairs for that partition and a total count of unique items for that partition. In addition, it is determined how to distribute processing of the buckets, such as by distributing processing of the buckets to multiple processors in a balanced way such that each processor generally incurs a similar amount of work.

For example, in order to determine affinity and lift for each possible pair of items, in accordance with an aspect, at least four stages of map/reduce jobs may be utilized. (The affinity/lift determination can also be implemented in a separate map/reduce job by joining the output from the item count stage.) The complexity of bucket filtering, item count and group materialization stages are all in linear relationship with number of <bucket, item> pairs in the input. However, the pair count determination is more complex.

For example, a bucket having 100 corresponding item transactions could have =100!/(98!*2!)=4950 pairs of items generated while a bucket with 10 corresponding item transactions only has =45 pairs of items generated. So a task taking 100 buckets with 495,000 total pairs will take 100 times longer to finish than a task taking 100 buckets with 4,500 total pairs. If the amount of work during pair generation is not distributed well among all the processes, a few processes may take most of time, which can essentially eliminate any benefits introduced by using a map/reduce platform. Thus, it can be significant to distribute all the buckets in a balanced way such that each process gets a similar amount of work.

Also, the bucket and item indications may be arbitrarily long strings, which are computationally expensive to manipulate (such as to compare one string to another string) and store. By using an integer or other easily-manipulable code to represent the strings, a lot of disk and memory space can be saved and, also, computational performance may be increased.

Still referring to FIG. 1, a second phase 110 of map/reduce processing includes item count processing, in which it is determined, for each item, a count of the number of appearances of each item in all the buckets collectively. Furthermore, in the second phase 110, an integer encoding is determined for each item, where the integer encoding of each item is based at least in part on the item distribution determined in the first phase 108.

A third phase 112 of the map/reduce processing includes bucket materialization. More specifically, for each bucket, all item integer codes for items transacted in correspondence with that bucket are collected into one record for that bucket. Further, for each bucket, the one record for that bucket is processed to determine a number of item pairs that can be generated for that bucket and integer encoding that bucket based at least in part on the determined number of item pairs that can be generated for that bucket.

In a fourth phase 114 of the map/reduce processing, a pair count and affinity/lift determination is carried out. In particular, pairs of item codes are generated, and affinity statistics are determined based on generated pairs of item codes.

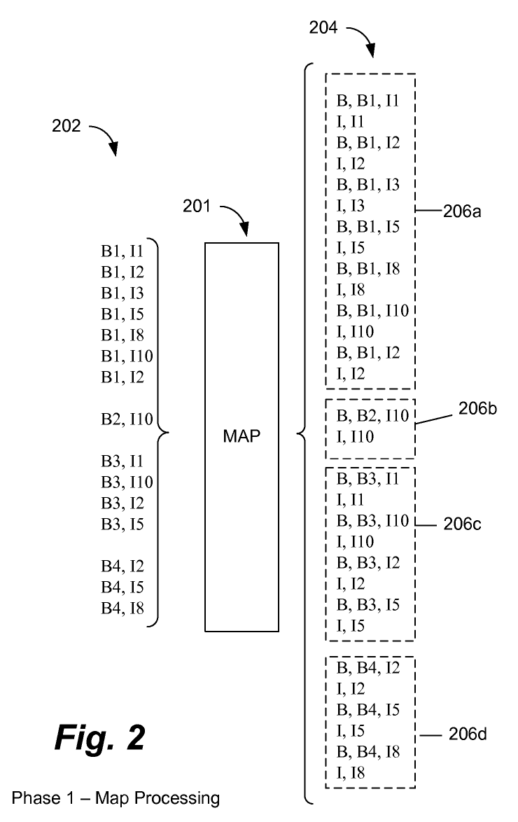

We now describe, more specifically, an example affinity/lift determination solution using a map-reduce architecture such as that shown in overview in FIG. 1, in which work is distributed in a balanced way to optimize performance. In addition, bucket and or item indications may be encoded (such as by an integer or other easily manipulable encoding) to increase computational and/or memory performance. We describe the example affinity/lift determination solution using the example input shown at the left side of FIG. 2, in which each input line is a <bucket, item> pair:

As mentioned above, a first map-reduce phase (Phase 1) is a bucket filtering and distribution determination phase. Thus for example, purpose(s) of this phase may include the following:
Remove duplicate items for the same bucket;
Remove buckets which contain only one item;
Determine the item distribution across partitions (such as by using a random hash based on an indication of the item); and
Determine the distribution of number of pairs across partitions (such as by using a random hash based on an indication of the bucket).

Thus, as illustrated in FIG. 2, the Phase 1 map stage 201 takes input 202 and provides output 204:
input: each line contains <bucket, item> pair
output: each input line leads to two output lines: <B bucket, item> and <I item, 1>
   As illustrated in FIG. 2, each box 206a to 206d corresponds to the output of the map stage 201 for a respective one of the buckets in the input 202.

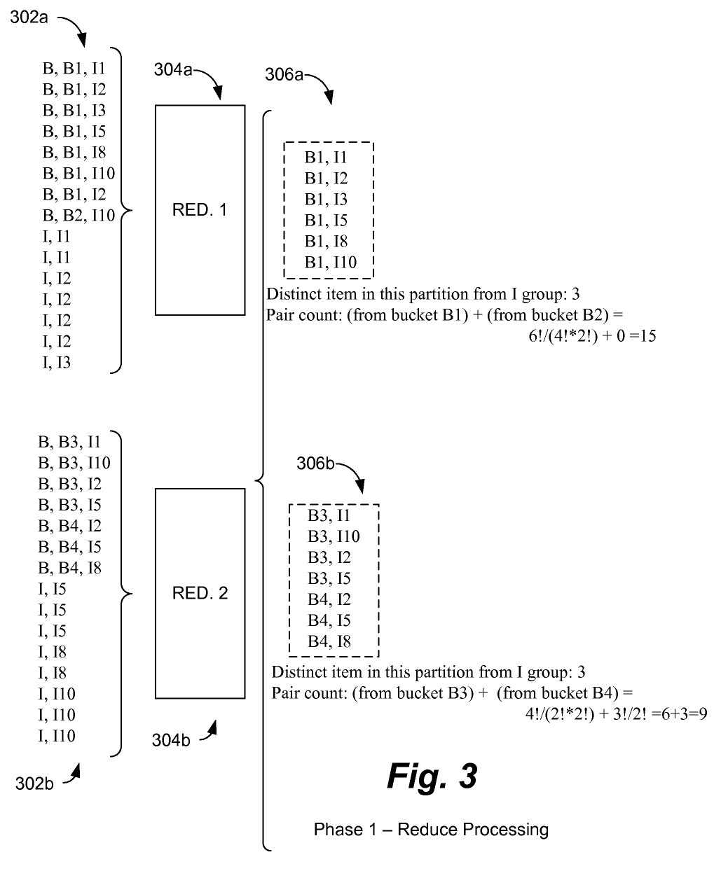

As also mentioned above, Phase 1 may also include a determination of items and pairs across processing partitions. For example, as illustrated in FIG. 3, if the key of the map stage 201 output line starts with B, then a partition to which reduce processing for that output line is assigned is based on a random has of the bucket indication. Further, if the key of the map stage 201 output line starts with I, then a partition to which reduce processing for that output line is assigned is based on a random hash of the item indication.

In addition to illustrating the partitioning, FIG. 3 also illustrates the Phase 1 reduce processing itself. In particular, as illustrated in FIG. 3, for reduce groups whose key starts with B, the reduce stage processing 304a and 304b (generically, 304) operates to filter out duplicates in the same bucket, i.e., to output, for each bucket, an indication of <bucket, item> if there is more than one item for that bucket. At the same time, the reduce stage 304 processing operates to count and output the total number of potential item pairs per reduce stage 304 partition. For example, if a partition 304 processes three B groups and each B group has 3, 5, and 4 items, respectively, then the total number of potential item pairs for this partition will be C₃²+C₅²+C₄²=3+10+6=19.

As can further be seen from FIG. 3, for reduce groups whose key starts with I, the reduce stage determines and outputs a total item count per partition. This total item count per partition can be used to determine the item distribution using a random hash. For example, for a reduce stage having four partitions, if the total item count per partition is 500, 2500, 5000, 12000, respectively, this means that the first, second, third and fourth partitions have 500, 2500, 5000, 12000 items respectively.

We now discuss an example of a second map-reduce phase (Phase 2) which is an item count and integer encoding phase. More specifically, purpose(s) of this phase may include the following:
Count the number of appearance for each item
Integer encoding of items

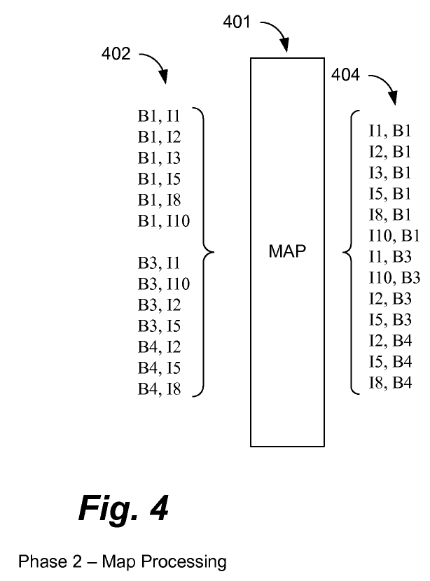

Thus, as illustrated in FIG. 4, the Phase 2 map stage 401 takes input 402 and provides output 404 as follows:
input: <bucket, item> pairs from last step
output: <item, bucket>

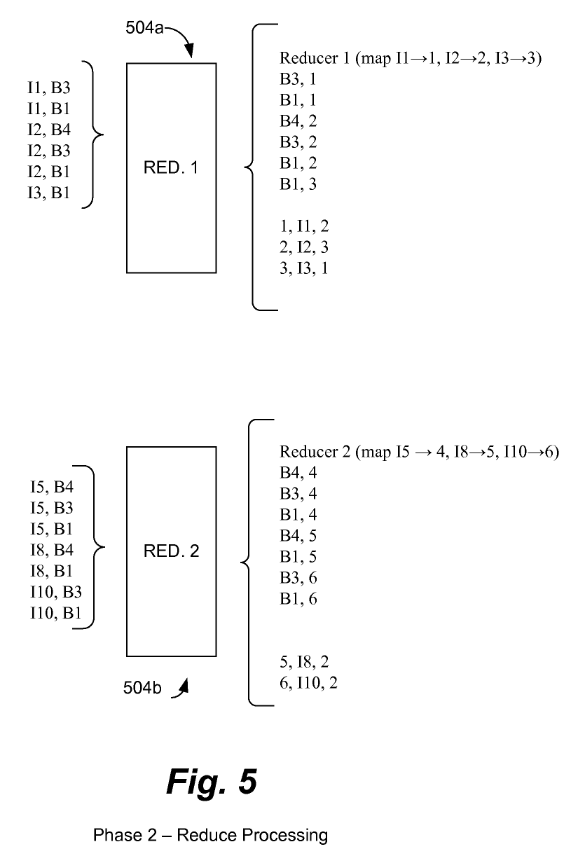

Phase 2 processing may also include a determination of allocation of items and pairs across processing partitions. For example, as illustrated in FIG. 5, if the key of the map stage 401 output line is a B, then a partition to which reduce processing for that output line is assigned may be based on a random hash of the bucket indication. Further, if the key of the map stage 201 output line is an I, then a partition to which reduce processing for that output line is assigned may be based on a random hash of the item indication.

With regard to the Phase 2 reduce 504 processing, the reduce processing determines the number of appearances for an item. Also, using the item distribution information from Phase 1, the start/end range of the items in each partition is known. An in-range integer number is used to encode each item. Using the example discussed above with respect to Phase 1 (in which the total item count per partition is 500, 2500, 5000 and 12000, respectively, the range of integers reserved for the first, second, third and fourth partition are [0-499], [500-2999], [3000-7999], and [8000-11999], respectively. So the item representation in string form is converted into a much more compact representation in integer form. The reducer output two sets of data in the form <bucket, item code> and <item code, item, item count>. In one example, each set of data goes to a separate file.

A third map-reduce phase (Phase 3) is a bucket materialization phase. More specifically, purpose(s) of this phase may include the following:
Put all the item codes belonging to the same bucket in the same line
Integer encoding of buckets

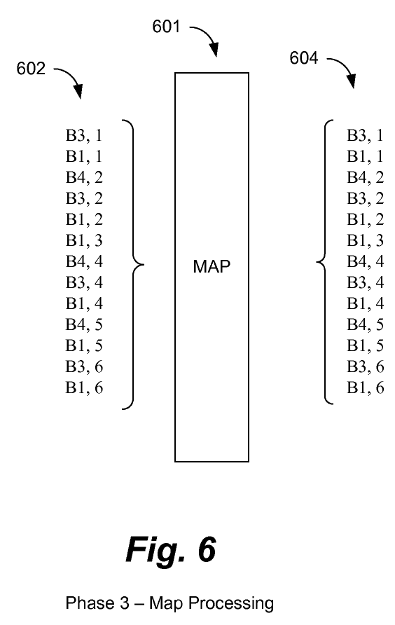

As illustrated in FIG. 6, the Phase 3 map processing 601 does no processing, merely providing the input 602 as output 604. The output of the FIG. 6 map processing may be partitioned using the same random hashing partition as described above with respect to Phase 1.

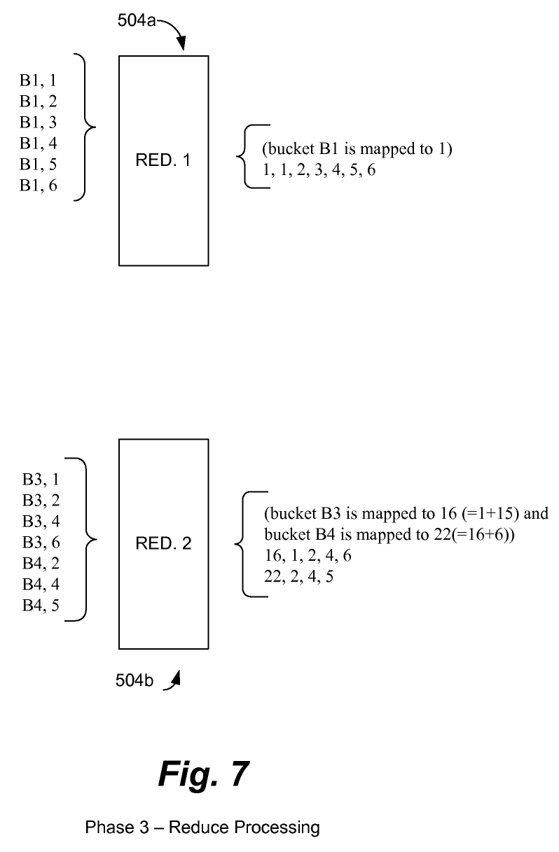

We now describe Phase 3 reduce processing, with reference to FIG. 7. By using the pair distribution information from Phase 1, the number of pairs that will be generated in each partition is known, and the boundary for each partition can be further represented as [start, end]. For example, assuming a partition is bounded by [2000, 2018] and there are three buckets generating 3, 10, 6 pairs respectively. Then those three buckets can be integer encoded as 2000, 2003, and 2013 respectively. Essentially, the integer code for a bucket indicates how many pairs can be generated before itself.

Thus, for each bucket, the reducer 504 output takes the form of <bucket code, item code 1, item code 2, . . . , item code K>. As a result, both bucket and item are represented by using integers.

A fourth map-reduce phase (Phase 4) is a pair-count phase. The phase 4 processing may accomplish a customized split based on a bucket code, such that buckets may be distributed to mappers so that each mapper generates a similar number of pairs. For example, the Phase 4 map processing may be such that the workload at each mapper is calculated as the total number of pairs divided by the number of mappers. Then, for each mapper, buckets are accumulated until the difference between the current bucket number and the start bucket number is greater than or equal to the allocated workload.

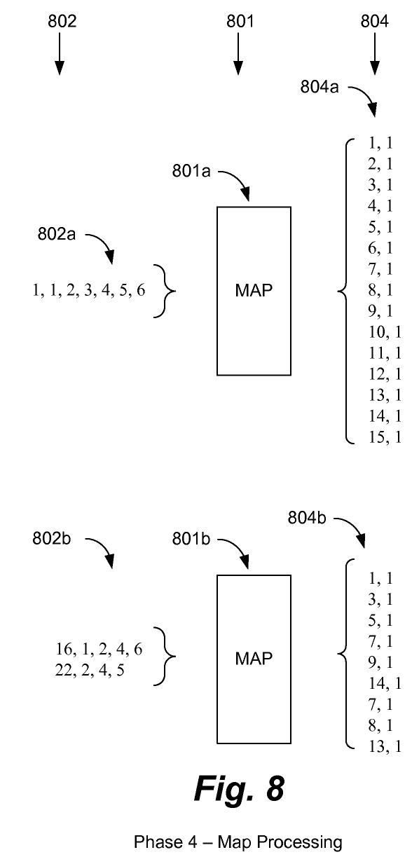

Referring to FIG. 8, the map stage may be generally termed as:
input: <bucket code, item code 1, item code 2, . . . , item code K>
output: for each item pair in the bucket, generate <pair code, 1>.
   Each item code pair is mapped to a pair integer code by using a matrix, similar to that described in U.S. Pat. No. 6,873,996, having the same assignee as the present application and incorporated by reference herein for all purposes.

In the Phase 4 processing illustrated in FIG. 8, the map stage 801 includes two mappers 801a and 801b. Continuing with the previous example, given the two mappers, the input 802a to the first mapper 801a is

1, 1, 2, 3, 4, 5, 6

The output 804a of the first mapper 801a (encoding each pair using following matrix):

| Item | 1 | 2 | 3 | 4 | 5 | 6 |
|---|---|---|---|---|---|---|
| 1 | | 1 | 2 | 3 | 4 | 5 |
| 2 | | | 6 | 7 | 8 | 9 |
| 3 | | | | 10 | 11 | 12 |
| 4 | | | | | 13 | 14 |
| 5 | | | | | | 15 |
| 6 | | | | | | |

is as follows:

1, 1

2, 1

3, 1

4, 1

5, 1

6, 1

7, 1

8, 1

9, 1

10, 1

11, 1

12, 1

13, 1

14, 1

15, 1

The input 804b to the second mapper 801b is

16, 1, 2, 4, 6

22, 2, 4, 5

The output 804b of the second mapper 801b is as follows:

1, 1

3, 1

5, 1

7, 1

9, 1

14, 1

7, 1

8, 1

13, 1

A two-dimensional block partition is carried out using the pair code, so each reduce of Phase 4 processing receives pairs in a particular item code range, e.g. first item code in range [x1-x2], the second item code in range [y1-y2], etc

For example, the reduce stage may carry out a pair count and affinity/lift calculation. In one example, first, the appearance of each pair is counted. Then, the pair code is mapped back to the item code, and the result is in the form <item code 1, item code 2, pair count>. By loading relevant other output from Phase 2, an item count look up and affinity/lift determination may be performed as follows,

Aff1=pair count/item1 count

Aff2=pair count/item2 count

lift1=lift2=pair count/(item1 count*item2 count)

Two rules can be output, <item1, item2, aff1, lift1>

and

<item2, item1, aff2, lift2 >

Only the relevant item code, item and item count need be loaded.

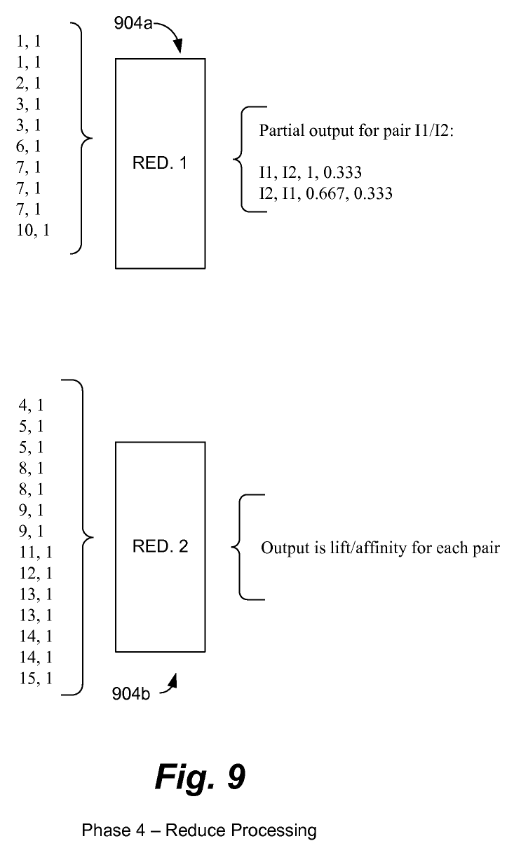

For example, referring to FIG. 9, for pair 1, the count is 2 and the item codes are 1 and 2. The relevant items are

1, I1, 2

2, I2, 3

So the affinity and lift can be determined as follows:

Affinity(I1, I2)=2/2=1

Affinity(I2, I1)=2/3=0.667

Lift(I1,I2)=Lift(I2,I1)=2/(2*3)=0.333

For example, the output for pair 1 will be:

I1, I2, 1, 0.333

12, I1, 0.667, 0.333

For simplicity of illustration, the remaining determined affinity/lift indications are not shown.

It can thus be seen that, with the use of a map-reduce parallel platform, pairwise affinity and lift determinations can be efficiently carried out. Furthermore, by using integer-encoding, computationally intensive operations of the map-reduce processing can be made more efficient.

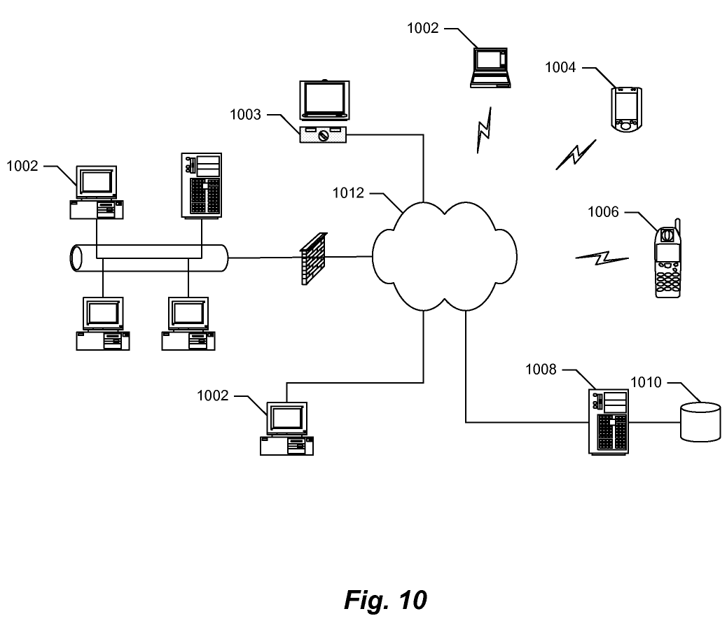

Embodiments of the present invention may be employed to facilitate affinity/lift determinations in any of a wide variety of computing contexts. For example, as illustrated in FIG. 10, implementations are contemplated in which users may interact with a diverse network environment via any type of computer (e.g., desktop, laptop, tablet, etc.) 1002, media computing platforms 1003 (e.g., cable and satellite set top boxes and digital video recorders), handheld computing devices (e.g., PDAs) 1004, cell phones 1006, or any other type of computing or communication platform.

According to various embodiments, applications may be executed locally, remotely or a combination of both. The remote aspect is illustrated in FIG. 10 by server 1008 and data store 1010 which, as will be understood, may correspond to multiple distributed devices and data stores.

The various aspects of the invention may also be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

What is claimed is:

1. A computer-implemented method of determining pair-wise item affinity based on transaction records tangibly embodied in at least one computer-readable medium, each transaction record including an indication of a bucket and an indication of a item transacted corresponding to that bucket, the method comprising:
executing computer code by at least one computing device of a computing system to determine, for each partition, a total number of potential item pairs for that partition and a total count of unique items for that partition;
executing computer code by at least one computing device of the computing system to perform an item count, comprising:
determining, for each item, a count of the number of appearances of each item in all the buckets collectively;
for each item, encoding that item based at least in part on the determined item distribution across partitions;
executing computer code by at least one computing device of the computing system to perform a bucket materialization, comprising:
for each bucket, collecting into one record all item codes for items transacted in correspondence with that bucket;
for each bucket, processing the one record for that bucket to determine a number of item pairs that can be generated for that bucket and encoding that bucket based at least in part on the determined pair distribution across partitions;
executing computer code by at least one computing device of the computing system to perform a pair count and affinity/lift calculation, comprising:
generating pairs of item codes, and generating affinity statistics based on generated pairs of item codes; and
causing the generated pairs of item codes an affinity statistics to be stored in a tangible computer-readable medium.

2. The method of claim 1, wherein:
in the item count, the encoding is determined additionally based on, for each of a plurality of ranges of codes, that an approximately same number of pairs of items is encoded into each of the plurality of ranges.

3. The method of claim 1, further comprising:
executing computer code by at least one computing device of the computing system to perform a mapping of generated pairs of item codes back to the item pairs.

4. The method of claim 3, wherein determining, for each bucket, a total number of potential items pairs for that partition and a total count of unique items for that partition comprises:
in map processing of a computer system, executing computer code by at least one computing device of the computing system to receive a plurality of <bucket, item> indications and to provide, for each <bucket, item> indication, a first indication marked with a bucket key, and indicating the bucket and item of that <bucket, item> indication and a second indication marked with an item key and indicating the item of that <bucket, item> indication;
in partition processing of the computing system, for each <bucket, item> indication, executing computer code by at least one computing device of the computing system to determine a random indication for that <bucket,item> indication based on one of the bucket and the item and assigning each <bucket, item> indication to a partition based at least in part on the random indication; and
in reduce processing of the computing system,
for first indications, marked with a bucket key,
for each bucket, for each item corresponding to that bucket, executing computer code by at least one computing device of the computing system to filter out duplicate indications and indications for buckets having only one item; and
executing computer code by at least one computing device of the computing system to determine total number of potential item pairs per partition; and
executing computer code by at least one computing device of the computing system to process second indications, marked with an item key, to determine a total item count for the partition.

5. The method of claim 1, wherein the item count comprises:
in map processing of the computing system, executing computer code by at least one computing device of the computing system to receive <bucket, item> indications and outputting an indication, for each <bucket, item> indication, of a corresponding <item, bucket> indication;
in partition processing of the computing system, for each <item, bucket> indication, executing computer code by at least one computing device of the computing system to determine a random indication for that indication based on the item and assigning each <item, bucket> indication to a partition based at least in part on the random indication;
in reduce processing of the computing system,
executing computer code by at least one computing device of the computing system to encode each item based at least in part on the determined item distribution across partitions; and
executing computer code by at least one computing device of the computing system to provide, for each <item, bucket>, an indication of <bucket, item code> and to provide, for each item, an indication of <item code, item, item count>.

6. The method of claim 1, wherein the bucket materialization step comprises:
in map processing of the computing system, executing computer code by at least one computing device of the computing system to receive <bucket, item code> indications and outputting an identical <bucket, item code>;
in partition processing of the computing system, executing computer code by at least one computing device of the computing system to partition the <bucket, item> codes for reduce processing as a result of a determination of a random indication for each <bucket,item> indication based on the bucket and to assign each <bucket, item> indication to a partition based at least in part on the random indication;
in reduce processing of the computing system, for each bucket, executing computer code by at least one computing device of the computing system to provide an indication for that bucket, the indication including the code determined for that bucket and the codes for all the items transacted by that bucket.

7. The method of claim 1, wherein the pair count and affinity/lift calculation comprises:
in map processing of the computing system, executing computer code by at least one computing device of the computing system to, based on the indications from the reduce stage of the bucket materialization, for each bucket, generate an indication including a pair code for each item pair;
in partition processing of the computing system, executing computer code by at least one computing device of the computing system to determine a partition for each pair code based on ranges of the pair codes; and
in a reduce stage, executing computer code by at least one computing device of the computing system to perform pair count, affinity and lift calculations.

8. The method of claim 7, further comprising:
in customized split stage processing, executing computer code by at least one computing device of the computing system to distribute buckets to mappers of the map processing of the computing system such that each mapper generates a similar number of item pairs, executing computer code by at least one computing device of the computing system according to a greedy algorithm.

9. A computing system configured to determine pair-wise item affinity based on transaction records tangibly embodied in at least one computer-readable medium, each transaction record including an indication of a bucket and an indication of an item transacted corresponding to that bucket, the computing system configured to:
execute computer code by at least one computing device of the computing system to determine, for each partition, a total number of potential item pairs for that partition and a total count of unique items for that partition;
execute computer code by at least one computing device of the computing system to perform an item count, comprising:
determining, for each item, a count of the number of appearances of each item in all the buckets collectively;
for each item, encoding that item based at least in part on the determined item distribution across partitions;
execute computer code by at least one computing device of the computing system to perform a bucket materialization, comprising:
for each bucket, collecting into one record all item codes for items transacted in correspondence with that bucket;
for each bucket, processing the one record for that bucket to determine a number of item pairs that can be generated for that bucket and encoding that bucket based at least in part on the determined pair distribution across partitions; and
execute computer code by at least one computing device of the computing system to perform a pair count and affinity/lift calculation, comprising:
generating pairs of item codes, and generating affinity statistics based on generated pairs of item codes; and
causing the generated pairs of item codes an affinity statistics to be stored in a tangible computer-readable medium.

10. The computing system of claim 9, wherein:
in the item count, the encoding is determined additionally based on, for each of a plurality of ranges of codes, that an approximately same number of pairs of items is encoded into each of the plurality of ranges.

11. The computing system of claim 9, the computing system further configured to:
execute computer code by at least one computing device of the computing system to perform a mapping of generated pairs of item codes back to the item pairs.

12. The computing system of claim 11, wherein being configured to execute computer code to determine, for each partition, a total number of potential items pairs for that partition and a total count of unique items for that partition comprises:
in map processing of a computer system, being configured to execute computer code by at least one computing device of the computing system to receive a plurality of <bucket, item> indications and to provide, for each <bucket, item> indication, a first indication marked with a bucket key, and indicating the bucket and item of that <bucket, item> indication and a second indication marked with an item key and indicating the item of that <bucket, item> indication;
in partition processing of the computing system, for each <bucket, item> indication, being configured to execute computer code by at least one computing device of the computing system to determine a random indication for that <bucket,item> indication based on one of the bucket and the item and assigning each <bucket, item> indication to a partition based at least in part on the random indication; and
in reduce processing of the computing system,
for first indications, marked with a bucket key,
for each bucket, for each item corresponding to that bucket, being configured to execute computer code by at least one computing device of the computing system to filter out duplicate indications and indications for buckets having only one item; and
being configured to execute computer code by at least one computing device of the computing system to determine total number of potential item pairs per partition; and
executing computer code by at least one computing device of the computing system to process second indications, marked with an item key, to determine a total item count for the partition.

13. The computing system of claim 9, wherein being configured to execute computer code for the item count comprises:
in map processing of the computing system, being configured to execute computer code by at least one computing device of the computing system to receive <bucket, item> indications and outputting an indication, for each <bucket, item> indication, of a corresponding <item, bucket> indication;
in partition processing of the computing system, for each <item, bucket> indication, being configured to execute computer code by at least one computing device of the computing system to determine a random indication for that indication based on the item and assigning each <item, bucket> indication to a partition based at least in part on the random indication;
in reduce processing of the computing system,
being configured to execute computer code by at least one computing device of the computing system to encode each item based at least in part on the determined item distribution across partitions; and
being configured to execute computer code by at least one computing device of the computing system to provide, for each <item, bucket>, an indication of <bucket, item code> and to provide, for each item, an indication of <item code, item, item count>.

14. The computing system of claim 9, wherein being configured to execute computer code for bucket materialization comprises:
in map processing of the computing system, being configured to execute computer code by at least one computing device of the computing system to receive <bucket, item code> indications and outputting an identical <bucket, item code>;
in partition processing of the computing system, being configured to execute computer code by at least one computing device of the computing system to partition the <bucket, item> codes for reduce processing as a result of a determination of a random indication for each <bucket,item>indication based on one of the bucket and the item and to assign each <bucket, item> indication to a partition based at least in part on the random indication;
in reduce processing of the computing system, for each bucket, being configured to execute computer code by at least one computing device of the computing system to provide an indication for that bucket, the indication including the code determined for that bucket and the codes for all the items transacted by that bucket.

15. The computing system of claim 9, being configured to execute computer code for the pair count and affinity/lift calculation comprises:
in map processing of the computing system, being configured to execute computer code by at least one computing device of the computing system to, based on the indications from the reduce stage of the bucket materialization, for each bucket, generate an indication including a pair code for each for each item pair;
in partition processing of the computing system, being configured to execute computer code by at least one computing device of the computing system to determine a partition for each pair code based on ranges of the pair codes; and
in a reduce stage, being configured to execute computer code by at least one computing device of the computing system to perform affinity and lift calculations.

16. The computing system of claim 15, the computing system further configured to:
in customized split stage processing, execute computer code by at least one computing device of the computing system to distribute buckets to mappers of the map processing of the computing system such that each mapper generates a similar number of item pairs, executing computer code by at least one computing device of the computing system according to a greedy algorithm.

17. A computer-program product comprising at least one computer readable medium having computer-executable code tangibly embodied thereon, the computer-executable code to configure at least one computing device to:
determine, for each partition, a total number of potential item pairs for that partition and a total count of unique items for that partition;
perform an item count, comprising:
determining, for each item, a count of the number of appearances of each item in all the buckets collectively;
for each item, encoding that item based at least in part on the determined item distribution across partitions;
perform a bucket materialization, comprising:
for each bucket, collecting into one record all item codes for items transacted in correspondence with that bucket;
for each bucket, processing the one record for that bucket to determine a number of item pairs that can be generated for that bucket and encoding that bucket based at least in part on the determined pair distribution across partitions; and
perform a pair count and affinity/lift calculation, comprising:
generating pairs of item codes, and generating affinity statistics based on generated pairs of item codes; and
causing the generated pairs of item codes an affinity statistics to be stored in a tangible computer-readable medium.

18. The computer program product of claim 17, wherein:
in the item count, the encoding is determined additionally based on, for each of a plurality of ranges of codes, that an approximately same number of pairs of items is encoded into each of the plurality of ranges.

19. The computer program product of claim 17, the computer program instructions further to configure the at least one computing device to:
perform a mapping of generated pairs of item codes back to the item pairs.

20. The computer program product of claim 19, wherein being configured to determine, for each partition, a total number of potential items pairs for that partition and a total count of unique items for that partition comprises:
in map processing of a computer system, being configured to receive a plurality of <bucket, item> indications and to provide, for each <bucket, item> indication, a first indication marked with a bucket key, and indicating the bucket and item of that <bucket, item> indication and a second indication marked with an item key and indicating the item of that <bucket, item> indication;
in partition processing of the computing system, for each <bucket, item> indication, being configured to determine a random indication for that <bucket,item> indication based on one of the bucket and the item and assigning each <bucket, item> indication to a partition based at least in part on the random indication; and
in reduce processing of the computing system,
for first indications, marked with a bucket key,
for each bucket, for each item corresponding to that bucket, being configured to filter out duplicate indications and indications for buckets having only one item; and
being configured to determine total number of potential item pairs per partition; and
by at least one computing device of the computing system to process second indications, marked with an item key, to determine a total item count for the partition.

21. The computer program product of claim 17, wherein being configured to perform the item count comprises:
in map processing of the computing system, being configured to receive <bucket, item> indications and outputting an indication, for each <bucket, item> indication, of a corresponding <item, bucket> indication;
in partition processing of the computing system, for each <item, bucket> indication, being configured to determine a random indication for that indication based on the item and assigning each <item, bucket> indication to a partition based at least in part on the random indication;
in reduce processing of the computing system,
being configured to encode each item based at least in part on the determined partition; and
being configured to provide, for each <item, bucket>, an indication of <bucket, item code> and to provide, for each item, an indication of <item code, item, item count>.

22. The computer program product of claim 17, wherein being configured for bucket materialization comprises:
in map processing of the computing system, being configured to receive <bucket, item code> indications and outputting an identical <bucket, item code>;
in partition processing of the computing system, being configured to partition the <bucket, item> codes for reduce processing as a result of a determination of a random indication for each <bucket,item> indication based on the bucket and assign each <bucket, item> indication to a partition based at least in part on the random indication;
in reduce processing of the computing system, for each bucket, being configured to provide an indication for that bucket, the indication including the code determined for that bucket and the codes for all the items transacted by that bucket.

23. The computer program product of claim 17, wherein being configured for the pair count and affinity/lift calculation comprises:
in map processing of the computing system, being configured to, based on the indications from the reduce stage of the bucket materialization, for each bucket, generate an indication including a pair code for each for each item pair;
in partition processing of the computing system, being configured to determine a partition for each pair code based on ranges of the pair codes; and
in a reduce stage, being configured to perform affinity and lift calculations.

24. The computer program product of claim 23, the computer program instructions further configured to cause the at least one computing device:
in customized split stage processing, to distribute buckets to mappers of the map processing of the computing system such that each mapper generates a similar number of item pairs, according to a greedy algorithm.
